(19) United States
(12) Patent Application Publication
(10) Pub. No.: US 2010/0030359 A1
(43) Pub. Date: Feb. 4, 2010

(54) METHOD AND APPARATUS FOR DESIGNING PARTS USING A MATERIALS PIPELINE

(76) Inventors: Thomas Stewart Luhman, Bellevue, WA (US); John Joseph Esposito, Auburn, WA (US); James Dean Cotton, Issaquah, WA (US); Eddy Joe Sharp, Seattle, WA (US); Gerould K. Young, Mercer Island, WA (US)

Correspondence Address: DUKE W. YEE, YEE & ASSOCIATES, P.C., P.O. BOX 802333, DALLAS, TX, 75380, US

(21) Appl. No.: 11/756,677

(22) Filed: Jun. 1, 2007

(51) Int. Cl. G06F 17/50

(52) U.S. Cl. 700/106

(57) ABSTRACT

A computer implemented method, apparatus, and computer usable program code for designing a product using technology readiness levels for materials. Entries identifying materials and technology readiness levels for the materials are stored in a database. A first design is developed using a first material selected from the database, wherein the first material has a first technology readiness level identified from the database. A second design is developed using a second material selected from the database, wherein the second material has a second technology readiness level identified from the database. The first design is compared to the second design using the first technology readiness level and the second technology readiness level to form a comparison. A selection is made between the first design and the second design using the comparison.

### BACKGROUND INFORMATION

1. Field

The present invention relates generally to an improved data processing system and in particular to a method and apparatus for processing data. Still more particularly, the present invention relates to a method, apparatus, and computer usable program code for designing parts using materials having different technology readiness levels.

2. Background

In designing and building a product, one or more materials are used. A product may have different levels of complexity. For example, a product may be a single part or component, such as a strut, a connector, or a cover. In other cases, a product may be complex, such as an engine, a wing assembly, or an entire aircraft.

In designing products, a company may direct designers to use materials that are considered allowable for use in product design and development. These types of “allowable” materials are ones that have known properties. These allowables also may have allowable tolerances for the properties and known processes for creating these materials. With these types of material having known reproducible properties, a designer may design a product relying on those properties. Materials with properties that do not vary beyond set tolerances or ranges from batch to batch at different times are important for designing products that do not have unexpected variances in their performance.

Often times, this performance involves safety factors that are designed into the product based on the properties of materials that are selected for the product. For example, in designing a wing, the spars and ribs forming the structural components of the wing are required to carry various loads in order to avoid failure. The strength and rigidity of materials used for the structural components may be crucial for safety factors. As a result, variances in the properties materials are undesirable.

Identifying materials that have reproducible properties is a time consuming and expensive process. Typically, materials are provided by vendors along with data regarding the properties, test performed, and processes used to create the materials. Alternatively, testing is typically performed on the materials received from a vendor to verify the expected consistency of the properties. Vendors may be required to implement processing procedures to ensure consistent properties for a particular material to have these materials considered for use in designing a product.

In many cases, the development of new materials is usually based from previously used materials that have been identified as allowable materials. The cost and time needed to test these types of materials is not as costly and time consuming as entirely new materials. As a result, the use of new materials in the designs does not occur as often as selecting allowable materials or variations in allowable materials.

### SUMMARY

The advantageous embodiments of the present invention provide a computer implemented method, apparatus, and computer usable program code for designing a product using technology readiness levels for materials. Entries identifying materials and technology readiness levels for the materials are stored in a database. A first design is developed using a first material selected from the database, wherein the first material has a first technology readiness level identified from the database. A second design is developed using a second material selected from the database, wherein the second material has a second technology readiness level identified from the database. The first design is compared to the second design using the first technology readiness level and the second technology readiness level to form a comparison. A selection is made between the first design and the second design using the comparison.

In another advantageous embodiment for designing a product, properties for use in designing the product are identified to form identified properties. Materials are identified in a database using the properties, wherein each material in the plurality of materials is associated with a technology readiness level. Designs are generated using the plurality of materials. A design is selected from the designs using the technology readiness level associated with each material.

In yet another advantageous embodiment, a computer program product contains a computer usable medium having computer usable program code for designing a product using technology readiness levels for materials. Computer usable program code stores records identifying materials and technology readiness levels for the materials in a database. The computer usable program product includes computer program code to develop a first design using a first material selected from the database, wherein the first material has a first technology readiness level from the database. The computer usable program product includes computer usable product code for developing a second design using a second material selected from the database, wherein the second material has a second technology readiness level from the database. The computer usable program product also includes computer usable program code for comparing the first design to the second design using the first technology readiness level and the second technology readiness level to form a comparison. The computer usable program code in the computer program product selects between the first design and the second design using the comparison.

The features, functions, and advantages can be achieved independently in various embodiments of the present invention or may be combined in yet other embodiments in which further details can be seen with reference to the following description and drawings.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an advantageous embodiment of the present invention when read in conjunction with the accompanying drawings, wherein:

FIG. 1 is a pictorial representation of a network of data processing systems in which illustrative embodiments of the present invention may be implemented;

FIG. 2 is a diagram of a data processing system in accordance with an illustrative embodiment of the present invention;

FIG. 3 is a diagram illustrating a system for designing products in accordance with an advantageous embodiment of the present invention;

FIG. 4 is a diagram illustrating an entry for a materials database in accordance with an advantageous embodiment of the present invention;

FIG. 5 is a diagram illustrating technology readiness levels in accordance with an advantageous embodiment of the present invention;

FIG. 6 is a flowchart of a process for introducing materials into a materials pipeline in accordance with an advantageous embodiment of the present invention;

FIG. 7 is a flowchart of a process for creating a design using the material in accordance with an advantageous embodiment of the present invention; and

FIG. 8 is a flowchart of a process for comparing properties and technology readiness levels of materials in accordance with an advantageous embodiment of the present invention.

### DETAILED DESCRIPTION

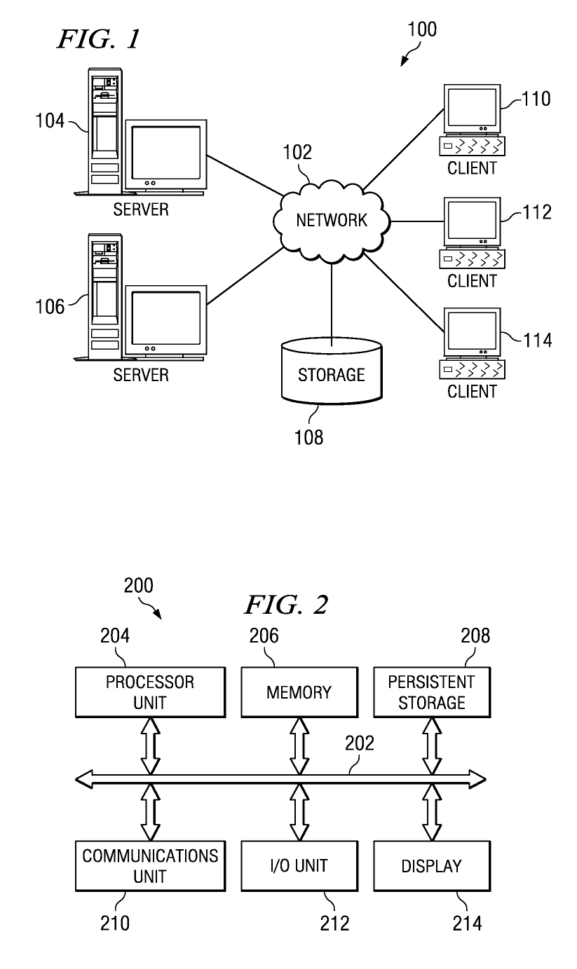

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Turning now to FIG. 2, a diagram of a data processing system is depicted in accordance with an illustrative embodiment of the present invention. Data processing system 200 is an example of an apparatus that may be used to implement computers, such as server 104 and client 114 in FIG. 1. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. Memory 206, in these examples, may be, for example, a random access memory. Persistent storage 208 may take various forms depending on the particular implementation. For example, persistent storage 208 may be, for example, a hard drive, a flash memory, a rewritable optical disk, a rewritable magnetic tape, or some combination of the above.

Communications unit 210, in these examples, provides for communications with other data processing systems or devices. In these examples, communications unit 210 is a network interface card. I/O unit 212 allows for input and output of data with other devices that may be connected to data processing system 200. For example, I/O unit 212 may provide a connection for user input though a keyboard and mouse. Further, I/O unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206.

The different advantageous embodiments of the present invention recognize that currently material development is not driven by design needs. Instead, material selections for new designs are typically based off of recent and similar designs. In many cases, materials from related designs are reused because these materials are ones that have been proven as having reproducible properties.

Access to these materials is typically through a database or repository of allowable materials. These types of materials also are referred to just as “allowables”. These allowable materials typically have a technology readiness level that is approved for implementation in products. In these examples, a technology readiness level is a measure used to assess the maturity of different materials prior to incorporating those materials into a product. In the advantageous embodiments, a technology readiness level may vary from one all the way through nine. One indicates only an identification of a few basic structural properties while a nine indicates that the material is ready to be used as an allowable.

The advantageous embodiments of the present invention provide a materials database that includes technology readiness level attributes associated with the different materials. Further, outside sources of materials, such as vendors or other manufacturers, may input data into this database for evaluation. As a result, design tools may be used to assess and develop designs with developmental materials data. Moreover, in this database, the cost and time associated with increasing a technology readiness level of a material also is identified.

Thus, the advantageous embodiments of the present invention provide a computer implemented method, apparatus, and computer usable program code for designing a product using technology readiness levels for materials. Entries identifying materials and technical readiness levels for these materials are stored in a database. With this information, a first and second design may be developed. The first design is developed using a first material from the database in which this material has a first technology readiness level. A second design may be developed using a second material selected from the database in which the second material has a second technology readiness level. The first design may be compared to the second design using the first technology readiness and the second technology readiness level to form a comparison. A selection between the first design and second design may be made using this comparison. This comparison may include identifying the cost needed to increase the technology readiness level of each of these materials to the desired technology readiness level.

In some cases, one selected material may have the technology readiness level that makes that material an allowable material. In other cases, the technology readiness level may be such that the amount of time and cost needed to increase the technology readiness level to the desired level is outweighed by the benefits of using that material as compared to the other material that may have a higher technology readiness level.

In addition, the amount of time present before the product is required to be produced or finalized also may be taken into account. Consequently, materials with lower technology readiness levels may be feasible in cases where the amount of time before the product is to be produced is longer as compared to the time for other products.

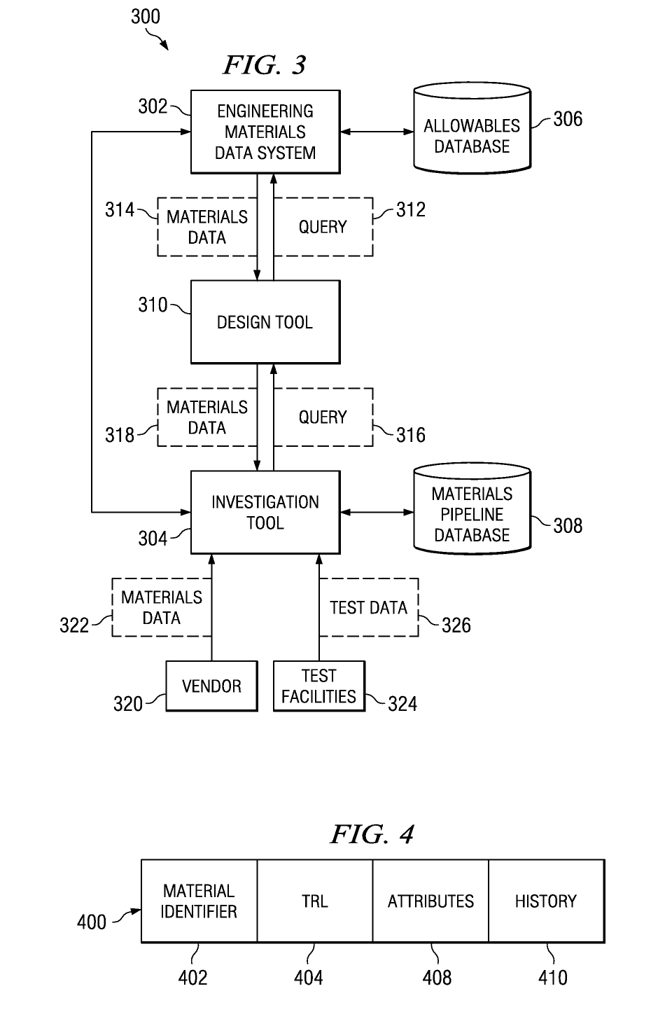

With reference next to FIG. 3, a diagram illustrating a system for designing products is depicted in accordance with an advantageous embodiment of the present invention. In this example, system 300 includes engineering materials data system 302 and investigation tool 304. Engineering materials data system 302 provides access to allowables database 306, while investigation tool 304 provides access to materials pipeline database 308. A database is a collection of data and the software processes needed to access the data.

Allowables database 306 is a materials database containing entries for materials that have already reached a technology readiness level that allows the materials found in this database to be used in producing products. The entries in allowables database 306 contain an identification of the technology readiness level as well as an identification of the properties and outside sources for the materials in these examples.

Materials pipeline database 308 is in essence a pipeline of materials in which the beginning of the pipeline contains materials with a technology readiness level of one. The technology readiness level of materials further down the pipeline increases until a technology readiness level of nine is present at the other end of the pipeline. This database provides designers access to materials having different technology readiness levels and allows the designers to consider these other materials in addition to allowable materials in generating designs for products.

In these examples, materials pipeline database 308 contains entries identifying materials having various technology readiness levels. Additionally, each entry also includes additional information that may be used to evaluate whether materials in materials pipeline database 308 may be feasible for a product design. Information, such as time and cost to increase the technology readiness level, properties of the materials, the tests performed on the materials, as well as processes used to reproduce the materials are examples of information that may be found in materials pipeline database 308 in addition to the technology readiness level identification.

In the illustrative examples, allowables database 306 and materials pipeline database 308 also may include histories that are associated with each material found in these databases. These histories contain results from receipt and inspection of materials. During receipt and inspection of materials, materials are tested to identify the values for different properties of the materials and see if these values meet the established requirements for those materials.

Even though the materials have been found acceptable, variances may occur within the acceptable tolerances. The data from testing the materials is saved in a history in these examples. An identification of these variances may be useful in identifying trends. For example, different manufacturers of a material may provide materials that vary differently within the acceptable tolerances or ranges for the different properties. Further, the variability in the properties may be affected by different environmental conditions, which may be identified through this historical data.

Allowables database 306 and materials pipeline database 308 are shown as separate logical databases in this example. These databases may be combined as a single database depending on the particular implementation. Further, depending on the implementation, allowables database 306 and materials pipeline database 308 may be a number of different databases in different locations.

Engineering materials data system 302 and investigation tool 304 provide access to these two databases regardless of their implementation and location such that each may be accessed by client data processing systems as a single database. Engineering materials data system 302 and investigation tool 304 are processes that may be found on a data processing system, such as server 104 or server 106 in FIG. 1.

Next, design tool 310 is an example of a software application or process that may be located in a client data processing system, such as client 110 or 114 in FIG. 1. In these examples, design tool 310 may be, for example, a computer aided design tool or other tool used to design products. Design tool 310 may identify materials in allowables database 306 through sending query 312 to engineering materials data system 302. In response, engineering materials data system 302 processes the query and returns a result from allowables database 306 as materials data 314.

Design tool 310 also may identify other materials that do not have the same technology readiness level as the allowable materials found in allowables database 306. Design tool 310 may send query 316 to investigation tool 304. In turn, investigation tool 304 queries materials pipeline database 308 to generate a result that is returned as materials data 318 to design tool 310. Further, design tool 310 may query both allowables database 306 and materials pipeline database 308 through engineering materials data system 302 or investigation tool 304 depending on the implementation.

In this type of implementation, a query sent to one of these components causes results being returned from both allowables database 306 and materials pipeline database 308. For example, query 316 may result in investigation tool 304 obtaining results from materials pipeline database 308. Further, investigation tool 304 also may use query 316 to allowables database 306 to return results through engineering materials data system 302. As another alternative, investigation tool 304 also may directly query allowables database 306.

In other words, the depicted embodiment in FIG. 3 is not meant to limit the manner in which queries may be made or sent. As another example, engineering materials data system 302 and investigation tool 304 may be combined in a single application depending on the particular implementation. The depicted components in the example are provided for purposes of illustrating the invention and are not intended to provide architectural limitations to the manner in which different features of the advantageous embodiments of the present invention may be implemented.

In addition to providing design tool 310 access to materials having various technology readiness levels, new materials may be added as entries in materials pipeline database 308 through investigation tool 304 in these examples. Vendor 320 may input new materials in materials pipeline database 308 through sending materials data 322 to investigation tool 304. The data may be entered, in these examples, through a website provided through investigation tool 304.

The materials data, in these examples, include an identification of the material as well as properties of the material. Further, materials data 322 also may include an identification of the tests performed on the material as well as processes used to create the material.

In the illustrative embodiments, properties for a material are the different properties about the material that may be used in determining whether to use the material in a design. A property of material is typically a quantitative property of a material usually with a unit that may be used as a metric of value to compare the benefits of one material verses the benefits of another material for a given product. Some properties of materials also are used in relevant equations to determine the attributes of a product prior to producing the product.

The properties may include mechanical properties, electrical properties, thermal properties, chemical properties, magnetic properties, optical properties, acoustical properties, radiological properties, and biological properties for a material. More specifically, these properties may include, for example, strength, compressive strength, shear strength, ductility, malleability, hardness, impact toughness, electrical connectivity, dielectric strength, thermoconductivity, heat of vaporization, heat of fusion, and others.

Upon receiving materials data 322, investigation tool 304 is used to identify a technology readiness level for the materials submitted by vendor 320. Each material has a pedigree in these examples. The pedigree defines a developmental status of a material. The pedigree includes, for example, how the material is produced, tests performed on the material, and variations in the material. The tests used by the vendor may not be the standard test used to determine technology readiness levels. However, the pedigree is still useful in determining an initial technology limits level.

If a pedigree contains a test or process that is not standard with the particular organization evaluating the material, a lower technology readiness level may be assigned as a conservative decision. As the technology readiness level increases, once the material is introduced into the organization, the pedigree becomes more and more similar to those for other materials because tests and processes to produce materials are then standardized for particular types of materials in these examples.

This type of testing may be performed by test facility 324, which may be a facility that is part of the organization or an external third party facility. Test facility 324 may be used to perform tests on materials and identify manufacturing processes for the materials needed to reduce variability in the production of the materials. Test facility 324 sends test data 326 to investigation tool 304 for analysis and inclusion in materials pipeline database 308.

Materials data 322 is placed into material pipeline database 308 after processing by investigation tool 304. This information provides an input into the pipeline for materials pipeline database 308. As testing and development of materials in materials pipeline database 308 occurs, the different materials “flow in a pipeline towards a technology readiness level that allows for the material to be used in products.”

In this manner, system 300 provides a user an ability to access and compare materials having various technology readiness levels. A user at design tool 310 may select a second material from materials pipeline database 308 having a lower technology readiness level than a first material in allowables database 306 for the design of a part. This choice may be made based on an analysis of the cost and time needed to increase the technology readiness level of the second material in materials pipeline database 308 over the presently usable first material in allowables database 306.

For example, the second material for materials pipeline database 308 may have superior properties over the first material in allowables database 306. For example, the second material may have a higher strength and corrosion resistivity than the first material. The drawback however, is the technology readiness level of the second material does not allow for the second material to be immediately used in producing a product.

Depending on the time and cost needed to increase the technology readiness level of the second material for use in a product, the second material may be a better choice than the first material even though the second material is not quite ready for use in producing the product. For example, in designing a part, a second material may have better properties than a first material.

In other words, the second material may provide a product that performs better than using the first material. However, if the product is a part for an aircraft that is in the developmental stage with a prototype being targeted for several years down the road, the second material may be a better choice because of the time that is available to increase the technology readiness level of the second material. On the other hand, if the product is a part for an aircraft that is to go into production within a few months, then the selection of the first material may be a better choice based on the time and cost needed to increase the technology readiness level of the second material.

With this architecture within system 300, different designer in different groups or teams within an organization may all access information about materials having different technology readiness levels in generating designs for products. As can be seen, through the use of system 300, multiple data entry sources are present for use by designers within an organization. Further, the different designers all have access to the same data regarding materials through this type of architecture.

In this manner, system 300 allows for designs to be optimized for material performance using both allowable materials and developmental materials. System 300 also increases the likelihood that materials will be pulled through the materials pipeline to increase the technology readiness levels as defined by the organization. Furthermore, investigation tool 304 in system 300 also allows for the inspection of receiving data from vendors.

Turning now to FIG. 4, a diagram illustrating an entry for a materials database is depicted in accordance with an advantageous embodiment of the present invention. Entry 400 is an example of an entry that may be found in a materials database, such as allowables database 306 and materials pipeline database 308 in FIG. 3. Entry 400 includes material identifier 402, technology readiness level (TRL) 404, attributes 408, and history 410.

Material identifier 402 is used to identify the material, and may include, for example, a name of the material and an identifier for the material. This identifier may be a unique identifier that is unique within the database. Alternatively, the identifier may be a product identifier assigned by the vendor depending on the implementation. Further, the source or name of the vendor also may be located within material identifier 402.

Technology readiness level 404 identifies the technology readiness level for this material. Additionally, entry 400 also contains attributes 408. These attributes may include the properties of the material. Attributes 408 also may include an identification of manufacturing processes used to create the material. In addition, these attributes also may identify the cost and time needed to increase the technology readiness level from its current technology readiness level to the next level. In these examples, the cost and time for increasing the technology readiness level may be made in a number of different ways depending on the implementation.

For example, an identification may be made for the time and cost to increase the technology readiness level from one level to another level based on different factors. For example, an identification of the testing, materials needed, and manufacturing readiness may be identified for increasing the technology readiness level of a material. Increasing material from a technology readiness level of one to a technology readiness level of two differs from the time and cost needed to increase the same material from a technology readiness level of six to a technology readiness level of seven.

Further, the class or type of materials also may result in different testing, manufacturing, and material requirements. These factors may be used to identify or approximate the time and cost needed to increase a material from one technology readiness level to another. With these estimates, the current technology readiness level of a material may be used to identify the time and cost needed to increase that material through each technology readiness level as well as an overall cost to increase the material to a technology readiness level that allows for that material to be used in a product.

History 410 is a history of the material. In particular, history 410 may contain data from receiving and inspecting the material over different periods of time. Depending on the implementation, the history may be located directly within history 410. Alternatively, history 410 may be a pointer to another data structure or database containing the history for the material. Other information used to evaluate the material also may be included in entry 400 depending on the particular implementation.

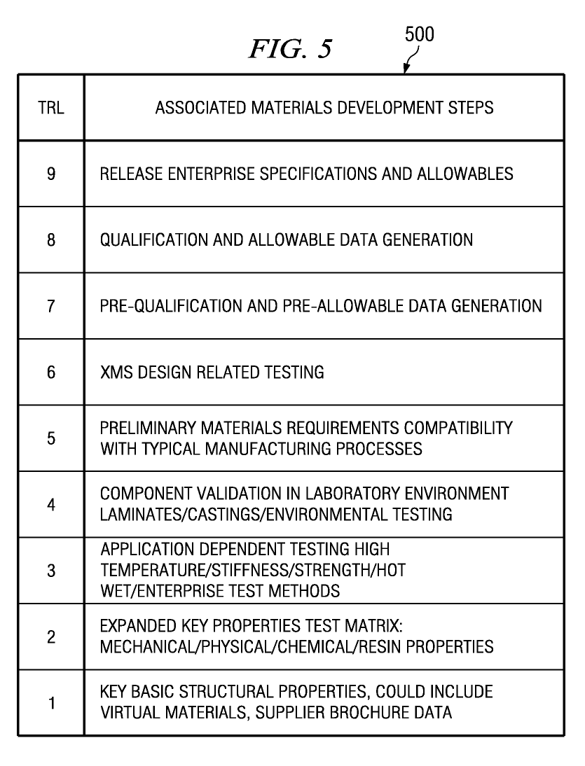

Turning now to FIG. 5, a diagram illustrating technology readiness levels is depicted in accordance with an advantageous embodiment of the present invention. Table 500 provides an identification of technology readiness levels that may be associated with materials in a materials database, such as allowables database 306 and materials pipeline database 308 in FIG. 3.

In this example, the technology readiness levels in table 500 vary in the entries from level one all the way through level nine with level nine being the highest technology readiness level. Of course, depending on the particular implementation, other scales may be used.

Typically, in these examples, when a vendor sends information for a material to be included in a materials pipeline database, an assessment of the data is made to assign a technology readiness level to the material. Depending on the testing performed on the material and the processes used to manufacture the material, the initial technology readiness level assigned to a material submitted by a vendor may vary. If the testing performed by the vendor does not use standard testing procedures outlined by the organization receiving the material data, the initial technology readiness level may be level one. If the vendor uses testing procedures that are standard to the organization, a higher technology readiness level may be assigned to the material submitted by the vendor.

In this example, technology readiness level one, in table 500 only requires two basic structural properties being identified. This information may be supplied by a vendor or some other third party. The material may have been tested by the vendor or third party, but has not yet been verified by the company or organization considering the material for use. Technology readiness level two requires expanded key properties test matrixes and may include more detailed information about the properties of a material that are identified from testing of the material.

These properties may be, for example, mechanical, physical, chemical, and/or resin properties. Technology readiness level three means that application dependent testing has occurred. Different test methods, such as high temperature, stiffness, strength, hot wet, and/or enterprise test methods may have been performed on the material having this technology readiness level. These tests are used to identify how well a material may perform for different applications. Technology readiness level four requires that component validation in a laboratory test environment has occurred. In other words, the material has been tested in technology readiness level to determine how well the material will perform in a product.

Next, technology readiness level five includes preliminary material requirements and compatibility with typical manufacturing processes. In table 500, technology readiness level six requires that an experimental material specification be present as well as design related testing. Technology readiness level eight requires qualification and allowable data generation. Technology readiness level nine means that the material is allowable material with release specifications that may be relied upon in designs.

The technology readiness levels illustrated in FIG. 5 are an illustration of one scale and definitions for different technology readiness levels that may be used. The technology readiness levels may differ depending on the particular implementation.

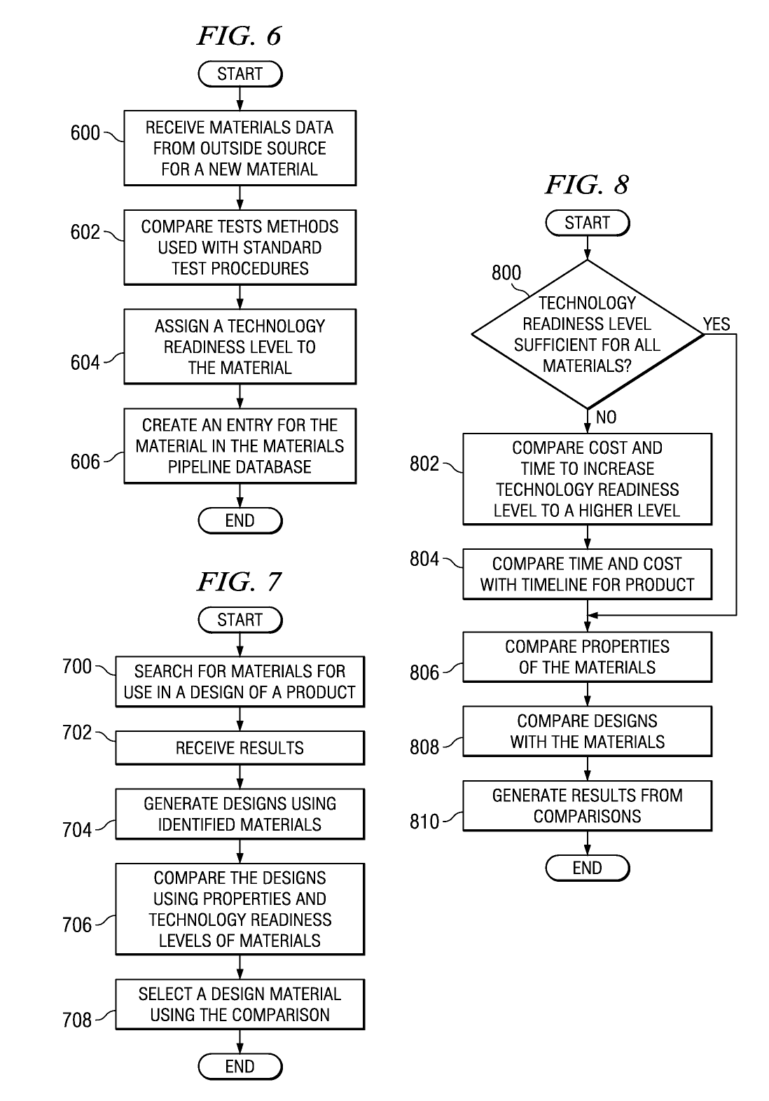

With reference now to FIG. 6 a flowchart of a process for introducing materials into a materials pipeline is depicted in accordance with an advantageous embodiment of the present invention. The process illustrated in FIG. 6 may be implemented in a software component, such as investigation tool 304 in FIG. 3.

The process begins by receiving materials data from an outside source for a new material (operation 600). In these examples, the materials data includes an identification of the material along with properties observed for the material. Further, this materials data also may include an identification of tests performed on the material to identify properties as well as test data. Depending on the maturity of the material, other data, such as processes used to produce the material as well as suggested uses may be included in the materials data.

Thereafter, the test methods identified in the materials data is compared with standard test procedures (operation 602). A technology readiness level is then assigned to the material (operation 604). If the test methods used by the source of the materials data follows the standard testing procedures used by the organization in assigning technology readiness levels, that information may be used to assign the technology readiness level to the material.

Additionally, the reliability of the source also may be taken into account even though tests may follow standard test procedures employed by the organization in assessing technology readiness levels. Further, if the testing procedures are not standard ones used by the organization, a low technology readiness level may be assigned, such as level one or two. Thereafter, an entry is created for the material in the materials pipeline database (operation 606) with the process terminating thereafter. This entry may take the form of an entry, such as entry 400 in FIG. 4.

With reference next to FIG. 7, a flowchart of a process for creating a design using the material is depicted in accordance with an advantageous embodiment of the present invention. The process implemented in FIG. 7 may be implemented in a software component, such as design tool 310 in FIG. 3.

The process begins by searching for materials for use in a design of a product (operation 700). Thereafter, results are received in response to the search (operation 702). In this example, operation 700 includes making one or more queries to a component, such as investigation tool 304 in FIG. 3. Thereafter, designs are generated using the identified materials (operation 704). In operation 704, two or more designs may be generated for comparison. The designs are then compared using the properties and the technology readiness levels of the materials (operation 706). In operation 706, the comparison is made with the materials in the designs to compare the performance of the different designs. Alternatively, the comparison could be made from the materials alone prior to implementing a selected material in a design. Thereafter, a design is selected for use in the design using the comparison (operation 708) with the process terminating thereafter.

Turning now to FIG. 8, a flowchart of a process for comparing properties and technology readiness levels of materials is depicted in accordance with an advantageous embodiment of the present invention. The process in FIG. 8 is a more detailed illustration of operation 704 in FIG. 7. The process begins by determining whether the technology readiness level is sufficient for all of the materials being considered (operation 800). If the technology readiness level is not sufficient for all of the materials, a comparison of the cost and time needed to increase the technology readiness level to a higher level is performed for those having insufficient technology readiness levels (operation 802).

Thereafter, the time and cost to increase the technology readiness levels is compared with the timeline for the project (operation 804). Next, a comparison of the properties of the materials is made (operation 806). The designs containing the materials are then compared (operation 808). The comparison in operation 808 may include an analysis of the products containing the different materials. Further, simulated tests may be run on the different products to identify how the different materials perform when integrated with other components in the product. Other types of analysis or tests may be made using the designs in addition to or in place of these illustrative ones depending on the particular implementation. Results are then generated from the comparisons (operation 810) with the process terminating thereafter.

With reference again operation 800, if the technology readiness levels for all of the materials is sufficient, the process proceeds to operation 806 to compare the properties and materials. These results may be used to select a design or material for a design. This selection may be made by a user. The process may suggest or select a design based on these results for the user to approve.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different advantageous embodiments of the present invention provide a method, apparatus, and computer user program code for designing a part. A first material is selected for the part in which the first material has a first technology readiness level. A second material is selected for use in the part wherein the second material has a second technology readiness level. A decision is made between using the first material and the second material for the part using the first and second technology readiness materials to form a final material for the part. Alternatively, two different designs may be made for the parts and then comparisons made to decide between which materials to use.

The different advantageous embodiments provide a materials pipeline that may be accessed by designers throughout an organization. Further, this system also provides an ability for outside or third party sources to introduce new materials for consideration in designs. In this manner, more materials are available for designers to consider as well as increasing the speed at which materials may be developed for products since materials in different stages in the materials pipeline may be considered and used depending on their technology readiness levels and the time and cost needed to increase those technology readiness levels to a state for use in a product.

The description of the present invention has been presented for purposes of illustration and description, and is not intended to be exhaustive or limited to the invention in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the invention, the practical application, and to enable others of ordinary skill in the art to understand the invention for various embodiments with various modifications as are suited to the particular use contemplated.

What is claimed is:

1. A computer implemented method for designing a product using technology readiness levels for materials, the computer implemented method comprising:
storing plurality of entries identifying materials and technology readiness levels for the materials in a database;
developing a first design using a first material selected from the database, wherein the first material has a first technology readiness level from the database;
developing a second design using a second material selected from the database, wherein the second material has a second technology readiness level from the database;
comparing the first design to the second design using the first technology readiness level and the second technology readiness level to form a comparison; and
selecting between the first design and the second design using the comparison.

2. The computer implemented method of claim 1, wherein the storing step further comprises:
storing at least one of cost, cost to change the technology readiness level for material, material properties, processes used to make material, and supplier history for material.

3. The computer implemented method of claim 1, wherein comparing step further comprises:
comparing a cost and a time to develop at least one of the first material and the second material to a higher technology readiness level.

4. The computer implemented method of claim 3, wherein the comparing step further comprises:
comparing how much time is present before production of the product is to begin with a particular time needed to increase a technology readiness level for a material to a desired technology readiness level.

5. The computer implemented method of claim 3 further comprising:
generating a realist probability measure for the first design and the second design using the first technology readiness level and the second technology readiness level.

6. The computer implemented method of claim 1, wherein the database comprises a plurality of data bases.

7. A method for designing a product, the method comprising:
identifying properties for use in designing the product to form identified properties;
identifying a plurality of materials in a database using the properties, wherein each material in the plurality of materials is associated with a technology readiness level;
generating a plurality of designs using the plurality of materials; and
selecting a design from the plurality of design using the technology readiness level associated with each material.

8. The method of claim 7 further comprising:
storing a plurality of entries in the database, wherein each entry in the plurality of entries includes an identification of a material and a technology readiness level for the material.

9. The method of claim 8, wherein the storing step further comprises:
storing at least one of cost, cost to change the technology readiness level for material, material properties, processes used to make material, and supplier history for material.

10. The method of claim 7, wherein selecting step comprises:
identifying a cost and a time to develop each the plurality of materials that is not an allowable material to a higher technology readiness level to form a set of costs and time for consideration in selecting a design from the plurality of designs; and
choosing a design from the plurality of designs using the technology readiness level associated with each material and the set of costs and time.

11. The method of claim 10, wherein the choosing step includes:
comparing how much time is present before production of the product is to begin with a time needed to increase a technology readiness level for a material to a desired technology readiness level.

12. The method of claim 7, wherein the method is a computer implemented method using a design tool.

13. A computer program product comprising:
a computer usable medium having computer usable program code for designing a product using technology readiness levels for materials, the computer program product comprising:
computer usable program code for storing plurality of entries identifying materials and technology readiness levels for the materials in a database;
computer usable program code for developing a first design using a first material selected from the database, wherein the first material has a first technology readiness level from the database;
computer usable program code for developing a second design using a second material selected from the database, wherein the second material has a second technology readiness level from the database;
computer usable program code for comparing the first design to the second design using the first technology readiness level and the second technology readiness level to form a comparison; and
computer usable program code for selecting between the first design and the second design using the comparison.

14. The computer program product of claim 13, wherein the computer usable program code for storing plurality of entries identifying materials and technology readiness levels for the materials in a database further comprises:
computer usable program code for storing at least one of cost, cost to change the technology readiness level for material, material properties, processes used to make material, and supplier history for material.

15. The computer program product of claim 13, wherein computer usable program code for comparing the first design to the second design using the first technology readiness level and the second technology readiness level to form a comparison further comprises:
computer usable program code for comparing a cost and a time to develop at least one of the first material and the second material to a higher technology readiness level.

16. The computer program product of claim 15, wherein the computer usable program code for comparing the first design to the second design using the first technology readiness level and the second technology readiness level to form a comparison further comprises:
computer usable program code for comparing how much time is present before production of the product is to begin with a particular time needed to increase a technology readiness level for a material to a desired technology readiness level.

17. The computer program product of claim 15 further comprising:
computer usable program code for generating a realist probability measure for the first design and the second design using the first technology readiness level and the second technology readiness level.

18. The computer program product of claim 15, wherein the database comprises a plurality of data bases.
